(19) United States
(12) Patent Application Publication
(10) Pub. No.: US 2006/0213343 A1
(43) Pub. Date: Sep. 28, 2006

(54) Waste ejecting blade assemblies for hand-held cutting tools

(75) Inventors: Jonathan Edwards, Bremerton, WA (US); Timothy Gaidjiergis, Kingston, WA (US); Joseph Gaidjiergis, Renton, WA (US); Jesse Renecker, Kingston, WA (US); Scott Fladgard, Kingston, WA (US)

Correspondence Address: PERKINS COIE LLP;PATENT-SEA, P.O. BOX 1247, SEATTLE, WA, 98111-1247, US

(73) Assignee: Shear Technologies, Inc., Kingston, WA (US)

(21) Appl. No.: 11/092,159

(22) Filed: Mar. 28, 2005

(51) Int. Cl. B26D 1/00

(52) U.S. Cl. 83/13

(57) ABSTRACT

Waste ejecting blade assemblies for hand-held cutting tools and methods for cutting fiber-cement materials are disclosed herein. In one embodiment, the blade assembly includes first and second fingers attachable to the cutting tool, and a reciprocating cutting member between the first and second fingers. The cutting member includes a body pivotally coupled to the first and second fingers and a blade projecting from the body. The blade includes a top surface between opposing side surfaces and a waste ejection member at a rear portion of the top surface. The waste ejection member includes a ramp having a front edge, a back edge, and an inclined portion between the front and back edges. The inclined portion is canted toward the first or second finger and configured to direct a waste portion of the workpiece away from the blade toward the first or second finger.

### TECHNICAL FIELD

The present invention relates to waste ejecting blade assemblies for hand-held cutting tools, such as those used to cut fiber-cement siding.

### BACKGROUND

The exteriors of houses and other types of buildings are commonly covered with siding materials that protect the internal structures from external environmental elements. The siding materials are typically planks or panels composed of wood, concrete, brick, aluminum, stucco, wood composites, or fiber-cement composites. Wood siding is popular, but it is costly and flammable.

Wood siding also cracks causing unsightly defects, and it is subject to infestation by insects. Aluminum is also popular, but it deforms easily, expands and contracts in extreme climates, and is relatively expensive. Brick and stucco are also popular in certain regions of the country, but they are costly and labor intensive to install.

Fiber-cement siding (FCS) offers several advantages compared to other types of siding materials. FCS is made from a mixture of cement, silica sand, cellulose, and a binder. To form FCS siding products, a liquid fiber-cement mixture is pressed and then cured to form FCS planks, panels, and boards. FCS is advantageous because it is non-flammable, weather-proof, and relatively inexpensive to manufacture. Moreover, FCS does not rot or become infested by insects. FCS is also advantageous because it may be formed with simulated wood grains or other ornamental designs to enhance the appearance of a building. To install FCS, a siding contractor cuts the panels or planks to a desired length at a particular job site. The siding contractor then abuts one edge of an FCS piece next to another and nails the cut FCS pieces to the structure. After the

FCS is installed, trim materials may be attached to the structure and the FCS may be painted.

Although FCS offers many advantages over other siding materials, it is difficult and expensive to cut. Siding contractors often cut FCS with a circular saw having an abrasive disk. Cutting FCS with an abrasive disk, however, generates large amounts of very fine dust that creates a very unpleasant working environment. Siding contractors also cut FCS with shears having opposing blades, as set forth in U.S. Pat. No. 5,570,678 and U.S. Pat. No. 5,722,386, which are herein incorporated in their entireties by reference. Although the shears set forth in these patents cut a clean edge in FCS without producing dust, many siding contractors prefer to use a hand-held tool because they are accustomed to cutting siding with hand saws. Therefore, in light of the positive characteristics of FCS and the need for a hand-held cutting tool, it would be desirable to develop a hand-held cutting tool that quickly cuts clean edges through FCS without producing dust.

To meet the demand for a hand-held FCS cutting tool, the present inventors developed a hand-held tool with a reciprocating cutting blade that is the subject of U.S. Pat. No. 5,993,303 (“the '303 patent,” the entirety of which is incorporated herein by reference). The hand-held tool of the '303 patent includes a hand-held motor unit with a housing, a motor inside the housing, and a switch operatively coupled to the motor to selectively activate the motor. A head having a casing is attached to the housing of the motor unit. The head includes a reciprocating drive assembly coupled to the motor. The hand-held cutting tool also includes a blade set having a moving blade between first and second stationary fingers. The moving blade is coupled to the drive assembly to reciprocate between the first and second fingers.

In the operation of the original hand-held cutting tool, the fingers were placed on an FCS workpiece and the moving blade was driven from an open position below the workpiece to a closed position in the gap between the first and second fingers. As the blade moved from the open position to the closed position, it sheared the workpiece along both sides of the blade to form a cut in the workpiece approximately as wide as the gap between the first and second fingers.

An operator would accordingly push the tool along a cutting line as the blade reciprocated between the open and closed positions to cut the workpiece.

One drawback of the hand-held tool of the '303 patent is that the waste material removed from the workpiece (e.g., the kerf material) can obscure the cutting line. For example, the kerf material from the FCS workpiece travels along a cutting surface of the blade after being cut from the workpiece and rolls up or otherwise collects at a rear portion of the blade. As the tool moves along the cutting line, the amount of kerf material can become significant and obscure the operator's view of the cutting line, thus making it difficult to make straight and accurate cuts. Accordingly, it would be desirable to develop a hand-held cutting tool that provides increased visibility of the cutting line throughout the cutting process.

### BRIEF DESCRIPTION OF THE DRAWINGS

FIG. 1 is an isometric view of a hand-held cutting tool with a blade assembly having a waste ejection member in accordance with one embodiment of the invention.

FIG. 2 is a side elevational view of the blade assembly of FIG. 1.

FIG. 3 is a top plan view of the blade assembly of FIG. 1.

FIGS. 4A and 4B are front end views of a blade assembly and head in accordance with another embodiment of the invention.

FIG. 5 is a front end view of a blade assembly and head in accordance with yet another embodiment of the invention.

### DETAILED DESCRIPTION

A. Overview

The present invention is directed toward blade assemblies for cutting fiber-cement siding and/or other fiber-cement materials, as well as cutting tools and methods for cutting fiber-cement materials. In one embodiment of the invention, a blade assembly for a fiber-cement cutting tool can include a first finger and a second finger attachable to the cutting tool. The first finger has a first guide surface and a first interior surface transverse to the first guide surface. The second finger has a second guide surface and a second interior surface transverse to the second guide surface. The first and second interior surfaces are spaced apart from one another, and the first and second guide surfaces define a guide plane.

The blade assembly also includes a reciprocating cutting member between the first and second fingers. The cutting member has a body that is pivotally coupled to the first and second fingers and a blade projecting from the body. The blade includes a first side surface facing the first interior surface of the first finger, a second side surface facing the second interior surface of the second finger, a top surface between the first and second side surfaces, and a waste ejection member at a rear portion of the top surface. The waste ejection member includes a ramp having a front edge, a back edge, and an inclined portion between the front and back edge. The inclined portion is canted toward the first or second finger. In several embodiments, the inclined portion is canted toward the first or second finger at an angle of 20 degrees to 80 degrees.

Another embodiment of a blade assembly for a fiber-cement cutting tool in accordance with the invention includes a first finger and a second finger attachable to the cutting tool. The first finger has a first guide surface in a first guide plane and a first interior surface. The second finger has a second guide surface in a second guide plane and a second interior surface. The first and second interior surfaces are spaced apart from one another. In this embodiment, the first and second guide planes are offset from each other. For example, the first and second guide planes can be offset from each other by a distance of up to about 0.110 inch. In another embodiment, the first and second guide planes are offset from each other by about 0.0625 inch.

The blade assembly also includes a reciprocating cutting member between the first and second fingers. The cutting member has a body that is pivotally coupled to the first and second fingers and a blade projecting from the body. The blade includes a first side surface facing the first interior surface of the first finger, a second side surface facing the second interior surface of the second finger, and a top surface between the first and second side surfaces. The top surface includes an arcuate portion configured to be a cutting surface.

Another aspect of the invention is directed toward hand-held cutting tools for severing fiber-cement materials. In one embodiment, the cutting tool can include a hand-held motor unit having a housing, a motor inside the housing, and a switch operatively coupled to the motor to selectively activate the motor. The cutting tool can also include a head having a casing attached to the housing of the motor unit and a reciprocating drive assembly coupled to the motor. The cutting tool further includes a first and a second finger attachable to the head or motor unit. The first finger has a first guide surface and a first interior surface transverse to the first guide surface. The second finger has a second guide surface and a second interior surface transverse to the second guide surface. The first and second interior surfaces are spaced apart from one another, and the first and second guide surfaces define a guide plane.

The cutting tool can further include a reciprocating cutting member between the first and second fingers for severing fiber cement along a cutting path. The cutting member has a body that is pivotally coupled to the first and second fingers and a blade projecting from the body. The blade includes a first side surface facing the first interior surface of the first finger, a second side surface facing the second interior surface of the second finger, a top surface between the first and second side surfaces, and a waste ejection member at a rear portion of the top surface. The waste ejection member includes a ramp having a front edge, a back edge, and an inclined portion between the front and back edges. The inclined portion is canted toward the first or second finger.

A further aspect of the invention is directed toward a method for cutting fiber-cement materials. The method includes engaging a first surface of the fiber-cement with guide surfaces of two spaced-apart finger portions of a cutting tool and reciprocating a blade between the fingers in a direction transverse to the guide surfaces along a stroke between an open position and a closed position.

The method then includes moving the fiber-cement and/or the cutting tool relative to the other along a cutting path. The method further includes ejecting waste portions cut from the workpiece away from the blade toward one of the finger portions.

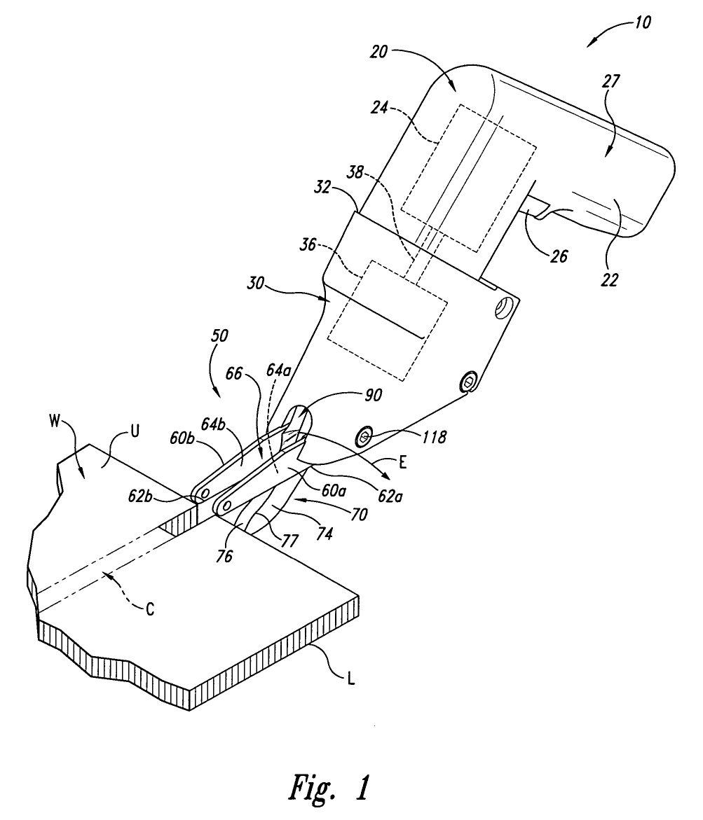

Many specific details of certain embodiments of the invention are set forth in the following description and in FIGS. 1-5 to provide a thorough understanding of such embodiments. One skilled in the art, however, will recognize that the invention can be practiced without one or more of the specific details explained in the following description. Moreover, although the following disclosure sets forth several embodiments of different aspects of the invention, several other embodiments of the invention can have different configurations or different components than those described in this section. As such, it should be understood that the invention may have other embodiments with additional elements or without several of the elements shown and described below with reference to FIGS. 1-5.

B. Embodiments of Hand-Held Cutting Tools With Waste Ejecting Blade Assemblies

FIG. 1 is an isometric view of a hand-held cutting tool 10 for cutting a fiber-cement material (FCM) workpiece W. The workpiece W has an upper surface U and a lower surface L. In the illustrated embodiment, the cutting tool 10 is cutting the workpiece W along a cutting line C. As described in detail below, a blade assembly 50 of the cutting tool 10 includes a waste ejection member 90.

The waste ejection member 90 is positioned on a cutting member 70 to eject a waste portion (e.g., kerf material) from the workpiece W away from the cutting tool 10 so that the kerf material does not block an operator's line of sight to the cutting line C, thereby enabling the operator (not shown) to make a straight and accurate cut along the cutting line.

The cutting tool 10 shown in FIG. 1 has a motor unit 20 with a housing 22, a motor 24 (shown schematically in phantom) inside the housing 22, and a switch 26 operatively coupled to the motor 24. The housing 22 preferably has a handle 27 configured to be gripped by the operator. Suitable electric motor units 20 include the No. 3208-90 electric motor unit manufactured by Black and Decker Corporation and the No. 0201-60 electric motor unit manufactured by Milwaukee Electric Tool Corporation. Suitable pneumatic motor units 20 include the No. 7802 pneumatic motor unit manufactured by Ingersoll-Rand Corporation and the No. 1446E-SLH pneumatic motor unit manufactured by Sioux Tools Incorporated.

The output of the motor unit 20 may be converted into a reciprocal motion with a head 30 having a casing 32 and a reciprocating drive assembly 36 (shown schematically in phantom). The casing 32 is attached to the housing 22 of the motor unit 20. Additionally, the reciprocating drive assembly 36 is coupled to the motor 24 via a gear assembly 38 (shown schematically in phantom) to translate the rotational output from the motor unit 20 into a reciprocating motion. A suitable head 30 is the shear head manufactured by Kett Tool Co., as set forth by U.S. Pat. No. 4,173,069, entitled “Power Shear Head,” which is herein incorporated by reference.

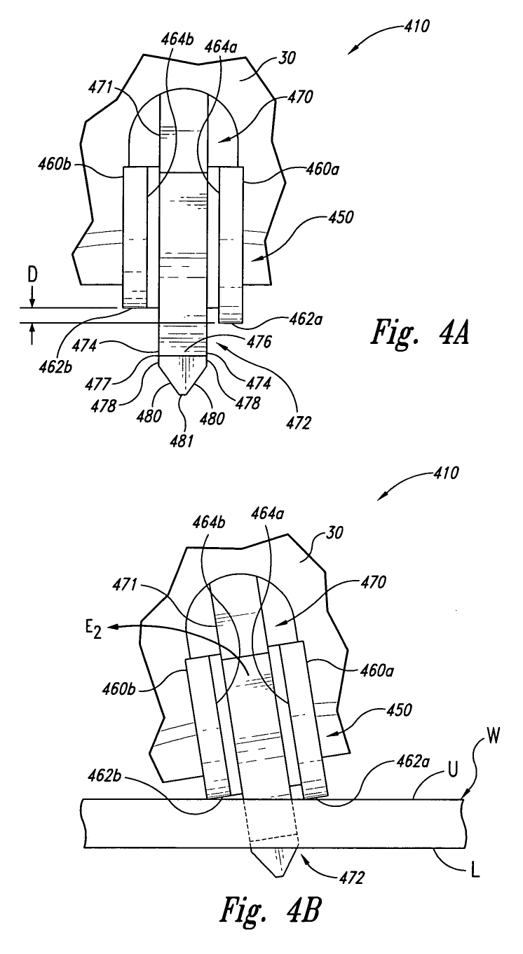

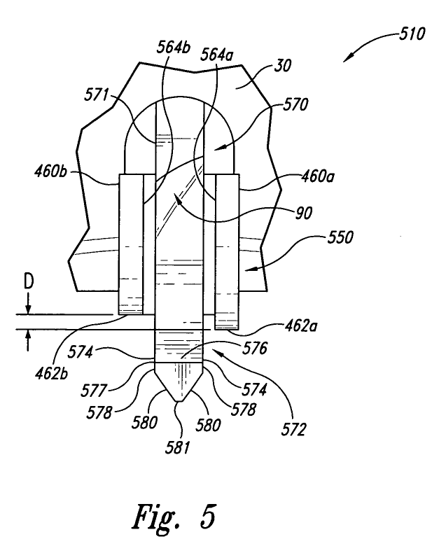

The blade set or assembly 50 includes a first finger 60a attached to one side of the head 30, a second finger 60b attached to another side of the head 30, and a cutting member 70 between the first and second fingers 60a and 60b. In one embodiment, the first finger 60a is separable from the second finger 60b. Alternatively, the first and second fingers 60a, 60b can be portions (e.g., integral portions) of a single alignment member. In either embodiment, the first finger 60a has a first guide surface 62a and a first interior surface 64a (shown in phantom). Similarly, the second finger 60b has a second guide surface 62b and a second interior surface 64b. The first and second fingers 60a and 60b are preferably attached to the head 30 to space the first and second interior surfaces 64a and 64b apart from one another by a gap 66 in which the cutting member 70 may be received. Additionally, the first and second guide surfaces 62a and 62b are preferably straight to rest flat on the upper surface U of the workpiece W for aligning the cutting member 70 with the workpiece W. In other embodiments described below with respect to FIGS. 4A-5, the first and second guide surfaces 62a and 62b can be offset from each other so that the cutting tool 10 does not rest completely flat on the workpiece W when cutting the workpiece.

In operation, a top surface 76 of the cutting member 70 lifts and separates the kerf material (not shown) from the workpiece W with each upward stroke of the cutting member 70. To cut a continuous line through the workpiece W, the operator (not shown) pushes the cutting tool 10 across the workpiece W as the cutting member 70 reciprocates. The kerf material from the workpiece W travels along the top surface 76 of the cutting member 70 to the waste ejection member 90. The kerf material is then ejected outwardly (as shown by the arrow E) away from the cutting member 70 and out of the operator's line of sight to the cutting line C.

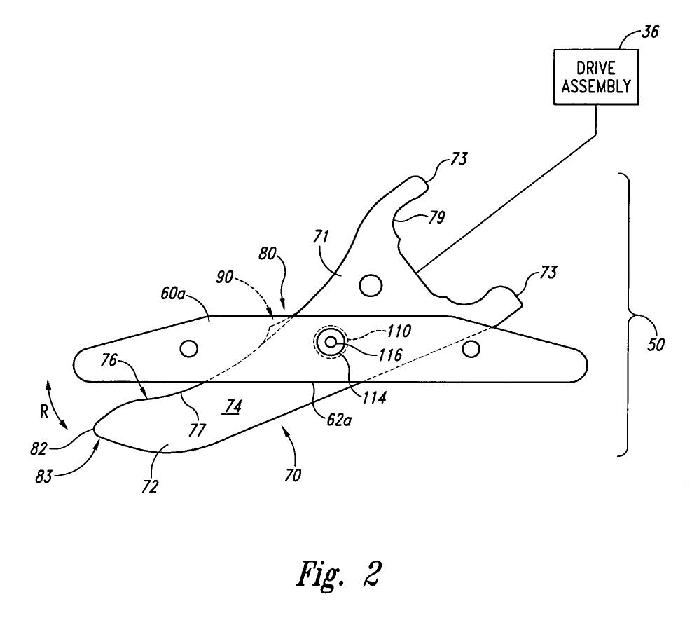

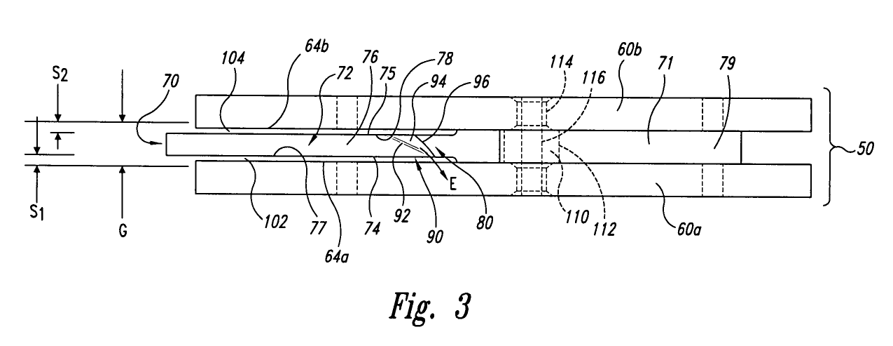

FIG. 2 is a side elevational view and FIG. 3 is a top plan view of the blade assembly 50 illustrated in FIG. 1. Referring to FIGS. 2 and 3 together, the cutting member 70 includes a body 71 with a first width approximately equal to a gap distance G (FIG. 3) between the first interior surface 64a of the first finger 60a and the second interior surface 64b of the second finger 60b. In alternate embodiments, the body 71 can have a width less than the gap distance G (FIG. 3) and one or more spacers (not shown) can be placed between the body 71 and the interior surfaces 64a-b of the fingers 60a-b. The cutting member 70 also includes a blade 72 projecting from the body 71 between the first and second fingers 60a and 60b. The blade 72 has a first side surface 74 facing the opposite direction as the first interior surface 64a, a second side surface 75 (FIG. 3) facing the opposite direction as the second interior surface 64b (FIG. 3), and the curved top surface 76. The edge along the top surface 76 and the first side surface 74 defines a first cutting edge 77, and the edge along the top surface 76 and the second side surface 75 (FIG. 3) defines a second cutting edge 78 (FIG. 3).

As best seen in FIGS. 1 and 3, the cutting member 70 further includes the waste ejection member 90 at a rear portion 80 of the top surface 76 of the blade 72. The waste ejection member 90 is a ramp positioned to direct the kerf material (not shown) from the workpiece W away from the blade 72 and out of the operator's line of sight to the cutting line C. The waste ejection member 90 includes a front edge 92, a back edge 96, and an inclined surface 94 between the front edge 92 and back edge 96. In the illustrated embodiment, the inclined surface 94 is canted toward the first finger 60a. In other embodiments, the inclined surface 94 may be canted toward the second finger 60b instead of the first finger 60a. The inclined surface 94 can be inclined at an angle of 20 degrees to 80 degrees. In one embodiment, for example, the inclined surface 94 is inclined at an angle of about 45 degrees. In other embodiments, the inclined surface 94 may be inclined at a different angle based on the material being cut and/or the thickness of the workpiece W. The waste ejection member 90 can be an integral portion of the cutting member 70, or the waste ejection member 90 can be a discrete element secured to the cutting member 70 at the desired location.

Referring back to FIG. 2, the top surface 76 of the cutting member 70 has a generally constant radius of curvature that is concave with respect to the guide surfaces 62a and 62b of the fingers 60a and 60b. Accordingly, the first and second cutting edges 77 and 78 (FIG. 3) are also concave with respect to the workpiece W. The curvature of the top surface 76 extends to be at least approximately coterminous with a front surface 82 of the cutting member 70. The length of the constant curvature on the top surface 76 provides a long cutting region (the portion of the cutting edges 77 and 78 that cut through the workpiece W) that can cut to a front portion 83 of the blade 72 as the blade 72 moves upward between the fingers 60a and 60b.

In the embodiment shown in FIG. 3, the first side surface 74 is spaced apart from the first interior surface 64a by a distance S₁ to define a first side space 102. Similarly, the second side surface 75 is spaced apart from the second interior surface 64b by a distance S₂ to define a second side space 104. The spacing between the sides 74 and 75 of the blade 72 and the interior surfaces 64a and 64b of the fingers 60a and 60b may be a function of the overall gap distance G between the fingers 60a and 60b. Additionally, the spacing between the sides of the blade and the fingers may be a function of the thickness and type of fiber-cement material of the workpiece W. For example, when the workpiece W is a fiber-cement panel or plank with a thickness of about 0.25-0.3125 inch, the side distances S₁ and S₂ are between 0.035-0.049 inch, and the gap distance G is approximately 0.25 inch. The spacing between the first and second side surfaces 74 and 75 and the fingers 60a and 60b may be selected by adjusting the thickness of the top surface 76 of the blade 72. In one embodiment, for example, with a gap distance G of 0.25 inch between the fingers 60a and 60b, the top surface 76 of the blade 72 may be 0.14 inch wide. It is expected that the particular dimensions (e.g., S₁, S₂, blade width) of the blade assembly 50 for cutting FCM material may be adjusted relative to the particular characteristics of the workpiece W.

Referring to FIGS. 2 and 3, the reciprocating cutting member 70 is pivotally coupled to the first and second fingers 60a and 60b by a bushing 110. The bushing 110 is generally cylindrical and has two side portions and a center portion with a larger radius. The center portion is received within an aperture 112 (FIG. 3) in the cutting member 70. The two side portions are received within an aperture 114 in each finger 60. The bushing 110 has an aperture 116 to receive a bolt 118 (shown in FIG. 1) to secure the bushing 110, the fingers 60a-b and the cutting member 70 to the head 30 (FIG. 1). The fingers 60a-b are also fixed to the head 30 by another bolt (not shown), and accordingly, only the cutting member 70 can pivot. In the illustrated embodiment, the fingers 60a-b are removable so that they can be changed when worn. In several embodiments, each finger 60 can have the same or similar ends so that the individual fingers 60 can be turned around when one end is worn. Furthermore, the first finger 60a is at least similar to the second finger 60b so that the fingers 60a-b are interchangeable. Cutting tools having interchangeable blades are described in greater detail in U.S. patent application Ser. No. 09/928,259 filed on Aug. 11, 2001, and incorporated by reference herein in its entirety.

The reciprocating cutting member 70 in the illustrated embodiment has a driven end 79 configured to engage the reciprocating drive assembly 36 (shown schematically in FIG. 2) of the head 30 (FIG. 1). The driven end 79 can have a fork shape with two spaced-apart teeth 73 (FIG. 2) that are alternately engaged by a rotating cam of the drive assembly 36. In operation, the motor 24 moves the drive assembly 36 when an operator depresses the switch 26. The drive assembly 36 reciprocates the blade 72 of the cutting member 70 along a reciprocating path R (FIG. 2) between an open position (FIGS. 1 and 2) and a closed position (not shown) in which the top surface 76 of the blade 72 is above the guide surfaces 62a and 62b of the fingers 60a and 60b. In one embodiment, the blade 72 reciprocates at approximately 100-3,000 strokes per minute. As the blade 72 moves from the open position to the closed position, the first cutting edge 77 and the first interior surface 64a shear the workpiece W along one line, and the second cutting edge 78 and the second interior surface 64b shear the workpiece along a parallel line.

One feature of the cutting tool 10 illustrated in FIGS. 1-3 is that the waste ejection member 90 on the blade 72 enables an operator to consistently make straight and precise cuts in the workpiece W. As described previously, an operator using a conventional cutting tool to make a long cut often encountered problems seeing the cut line because the kerf material would collect at the rear portion of the blade, blocking the operator's view of the line. In contrast, the waste ejection member 90 described above ejects the kerf material from the workpiece W out of the operator's line of sight, thus enabling the operator to view the cut line throughout the cutting operation and make a clean, straight edge along the cut.

C. Additional Embodiments of Hand-Held Cutting Tools with Waste Ejecting Blade Assemblies

FIG. 4A is a front end view of a portion of a cutting tool 410 having a blade assembly 450 configured for cutting an FCM workpiece W in accordance with another embodiment of the invention. The tool 410 can include several features generally similar to the cutting tool 10 described above; like reference numbers accordingly refer to like components in FIGS. 1-3 and FIG. 4A. The cutting tool 410 includes the motor unit (not shown) and the head 30 coupled to the motor unit to operate the blade assembly 450 in a manner generally similar to that discussed above.

In the illustrated embodiment, the blade assembly 450 includes two spaced-apart fingers 460 (identified individually as a first finger 460a and a second finger 460b). The first finger 460a has a first guide surface 462a and a first interior surface 464a. The first guide surface 462a defines a first guide plane that extends transverse to the plane of FIG. 4. Similarly, the second finger 460b has a second guide surface 462b and a second interior surface 464b. The second guide surface 462b defines a second guide plane that extends generally parallel to the first guide plane. The first guide plane is offset from the second guide plane by a distance D. The offset distance D is generally small because a large offset will cause inaccurate and/or uneven cuts in the workpiece. For example, the offset distance D can be a distance up to approximately 0.110 inch. More preferably, the offset distance D is approximately 0.0625 inch.

The blade assembly 450 can further include a cutting member 470 pivotally coupled to the head 30 between the fingers 460. The cutting member 470 can be generally similar to the cutting member 70 described above, except that the cutting member 470 does not include the waste ejection member 90. The cutting member 470 includes a body portion 471 coupled to a blade portion 472. The blade portion 472 includes a top surface 476 and a bottom surface 481. The blade portion 472 also has generally flat side surfaces 474 that face opposite the interior surfaces 464a-b of the fingers 460a-b. In one aspect of this embodiment, the side surfaces 474 are generally parallel to the interior surfaces 464a-b of the fingers 460a-b and extend from a top edge 477 (where the side surfaces 474 intersect the top surface 476) to an intermediate edge 478. The cutting member 470 also can have canted surfaces 480 extending from the intermediate edge 478 to the bottom surface 481 and converging toward each other.

FIG. 4B is a front end view of the cutting tool 410 of FIG. 4A cutting the workpiece W. In operation, the tool 410 is guided along the cutting line C (FIG. 1) to sever the workpiece W. The first and second guide surfaces 462a-b rest on the upper surface U of the workpiece W. As mentioned above, the first guide surface 462a is offset from the second guide surface 462b. Accordingly, the tool 410 is slightly tilted with respect to the upper surface U of the workpiece W. In the illustrated embodiment, for example, the tool 410 is slightly tilted from right to left (as shown in FIG. 4B) because the second guide plane (i.e., the second guide surface 462a) extends below the first guide plane (i.e., the first guide surface 462b). In other embodiments, the tool 410 may be tilted at a different angle with respect to the workpiece W and/or the tool 410 may be tilted in a different direction.

The blade portion 472 projects below the first and second guide surfaces 462a and 462b and reciprocates up and down between the fingers 460 to cut or sever the workpiece W. As the tool 410 moves along the cut line C (FIG. 1), the kerf material (not shown) from the workpiece W is ejected from the blade 472 in the direction of the second guide surface 462b (as shown by the arrow E₂) because of the offset orientation of the tool 410. In this way, the kerf material does not block the operator's line of sight to the cutting line.

The tool 410 can have many of the same advantages as the tool 10 described above with respect to FIGS. 1-3. For example, the offset orientation of the first and second guide surfaces 462a-b of the cutting tool 410 described above ejects the kerf material from the workpiece W out of the operator's line of sight, thus enabling the operator to view the cut line throughout the cutting operation and make a clean, straight edge along the cut.

FIG. 5 is a front end view of a portion of a cutting tool 510 having a blade assembly 550 configured for cutting an FCM workpiece in accordance with yet another embodiment of the invention. The tool 510 can include several features generally similar to the cutting tools 10 and 410 described above with respect to Figures 1-4B. For example, the tool 510 includes both the waste ejection member 90 and the fingers 460a-b having offset guide surfaces 462a-b. Accordingly, the tool 510 is expected to have many of the same advantages as the cutting tools 10 and 410 described above.

From the foregoing it will be appreciated that, although specific embodiments of the invention have been described herein for purposes of illustration, various modifications may be made without deviating from the spirit and scope of the invention. Accordingly, the invention is not limited except as by the appended claims.

I/We claim:

1. A blade assembly for a fiber-cement cutting tool, comprising:
a first finger having a first guide surface and a first interior surface transverse to the first guide surface, the first finger being attachable to the cutting tool;
a second finger having a second guide surface and a second interior surface transverse to the second guide surface, the second finger being attachable to the cutting tool to position the first and second guide surfaces in a guide plane and to space the first and second interior surfaces apart from one another; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a waste ejection member at a rear portion of the top surface, the waste ejection member including a ramp having a front edge, a back edge, and an inclined portion between the front and back edges, the inclined portion being canted toward the first or second finger.

2. The blade assembly of claim 1 wherein the inclined portion is canted toward the first finger at an angle of 20 degrees to 80 degrees.

3. The blade assembly of claim 1 wherein the inclined portion is canted toward the first finger at an angle of 45 degrees.

4. The blade assembly of claim 1 wherein the inclined portion is canted toward the second finger at an angle of 20 degrees to 80 degrees.

5. The blade assembly of claim 1 wherein the inclined portion is canted toward the second finger at an angle of 45 degrees.

6. The blade assembly of claim 1 wherein the top surface of the blade has a curvature concave with respect to the first and second guide surfaces.

7. The blade assembly of claim 1 wherein at least a portion of the top surface is configured to be a cutting surface.

8. The blade assembly of claim 1 wherein the top surface has an arcuate portion, and wherein at least a portion of the arcuate portion is configured to be a cutting surface.

9. The blade assembly of claim 1 wherein each of the first and second guide surfaces is flat to lie flush against a face of the workpiece while the workpiece is cut.

10. A blade assembly for a fiber-cement siding cutting tool, comprising:
a first finger having a first guide surface and a first interior surface transverse to the first guide surface, the first finger being attachable to the cutting tool;
a second finger having a second guide surface and a second interior surface transverse to the second guide surface, the second finger being attachable to the cutting tool to position the first and second guide surfaces in a guide plane and to space the first and second interior surfaces apart from one another; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a waste ejection member at a rear portion of the top surface configured to direct a waste portion of the workpiece away from the blade toward the first or second finger.

11. The blade assembly of claim 10 wherein the waste ejection member includes a ramp canted toward the first finger at an angle of 20 degrees to 80 degrees.

12. The blade assembly of claim 10 wherein the waste ejection member includes a ramp canted toward the first finger at an angle of 45 degrees.

13. The blade assembly of claim 10 wherein the waste ejection member includes a ramp canted toward the second finger at an angle of 20 degrees to 80 degrees.

14. The blade assembly of claim 10 wherein the waste ejection member includes a ramp canted toward the second finger at an angle of 45 degrees.

15. The blade assembly of claim 10 wherein the top surface of the blade has a curvature concave with respect to the first and second guide surfaces.

16. The blade assembly of claim 10 wherein at least a portion of the top surface is configured to be a cutting surface.

17. The blade assembly of claim 10 wherein the top surface has an arcuate portion, and wherein at least a portion of the arcuate portion is configured to be a cutting surface.

18. The blade assembly of claim 10 wherein each of the first and second guide surfaces is flat to lie flush against a face of the workpiece while the workpiece is cut.

19. A blade assembly for a fiber-cement siding cutting tool, comprising:
an alignment member attachable to the cutting tool and having a first finger portion with a first guide surface and a first interior surface transverse to the first guide surface, the alignment member further having a second finger portion with a second guide surface and a second interior surface transverse to the second guide surface, the first and second guide surfaces defining a guide plane and the first and second interior surfaces being spaced apart from one another; and
a reciprocating cutting member between the first and second finger portions and movable relative to the finger portions along a path transverse to the guide plane, the cutting member having a blade portion with a first side surface facing the first interior surface of the first finger, a second side surface facing the second interior surface of the second finger, a top surface between the first and second side surfaces, the top surface having an arcuate portion configured to be a cutting surface, and a ramp at a rear portion of the cutting surface, the ramp including an inclined surface between the first and second edges such that the inclined surface is canted toward the first or second finger.

20. The blade assembly of claim 19 wherein the inclined surface is canted toward the first finger at an angle of 20 degrees to 80 degrees.

21. The blade assembly of claim 19 wherein the inclined surface is canted toward the first finger at an angle of 45 degrees.

22. The blade assembly of claim 19 wherein the inclined surface is canted toward the second finger at an angle of 20 degrees to 80 degrees.

23. The blade assembly of claim 19 wherein the inclined surface is canted toward the second finger at an angle of 45 degrees.

24. The blade assembly of claim 19 wherein the top surface of the blade has a curvature concave with respect to the first and second guide surfaces.

25. The blade assembly of claim 19 wherein each of the first and second guide surfaces is flat to lie flush against a face of the workpiece while the workpiece is cut.

26. A blade assembly for a reciprocating fiber-cement siding cutting tool, comprising:
a first finger having a first guide surface and a first interior surface, the first finger being attachable to the cutting tool to position the first guide surface in a first guide plane;
a second finger having a second guide surface and a second interior surface, the second finger being attachable to the cutting tool to space the first and second interior surfaces apart from one another and to position the second guide surface in a second guide plane, wherein the first and second guide planes are offset from each other; and
a reciprocating cutting member pivotally coupled between the first and second fingers, the cutting member having a body and a blade projecting from the body, the body being pivotally coupled to the first and second fingers, the blade having a first side surface facing the first interior surface of the first finger, a second side surface facing the second interior surface of the second finger, and a top surface between the first and second side surfaces, the top surface having an arcuate portion configured to be a cutting surface.

27. The blade assembly of claim 26 wherein the first and second guide planes are offset from each other by less than about 0.110 inch.

28. The blade assembly of claim 26 wherein the first and second guide planes are offset from each other by about 0.0625 inch.

29. The blade assembly of claim 26 wherein:
the first finger has a first top surface opposite the first guide surface and a first thickness between the first top surface and the first guide surface; and
the second finger has a second top surface opposite the second guide surface and a second thickness between the second top surface and the second guide surface, and wherein the first thickness is greater than the second thickness.

30. The blade assembly of claim 26 wherein:
the first finger has a first top surface opposite the first guide surface and a first thickness between the first top surface and the first guide surface; and
the second finger has a second top surface opposite the second guide surface and a second thickness between the second top surface and the second guide surface, and wherein the first thickness is greater than the second thickness by about 0.0625 inch.

31. The blade assembly of claim 26 wherein:
the first finger has a first top surface opposite the first guide surface and a first thickness between the first top surface and the first guide surface; and
the second finger has a second top surface opposite the second guide surface and a second thickness between the second top surface and the second guide surface, and wherein the second thickness is greater than the first thickness.

32. The blade assembly of claim 26 wherein:
the first finger has a first top surface opposite the first guide surface and a first thickness between the first top surface and the first guide surface; and
the second finger has a second top surface opposite the second guide surface and a second thickness between the second top surface and the second guide surface, and wherein the second thickness is greater than the first thickness by about 0.0625 inch.

33. A blade assembly for a reciprocating fiber-cement siding cutting tool, comprising:
a first finger having a first guide surface and a first interior surface, the first finger being attachable to the cutting tool to position the first guide surface in a first guide plane;
a second finger having a second guide surface and a second interior surface, the second finger being attachable to the cutting tool to space the first and second interior surfaces apart from one another and to position the second guide surface in a second guide plane, wherein the first and second guide surfaces are offset from each other; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a waste ejection member at a rear portion of the top surface, the waste ejection member including a ramp having a front edge, a back edge, and an inclined portion between the front and back edges, the inclined portion being canted toward the first or second finger.

34. A cutting member for a hand-held cutting tool having a motor, a casing having a support adapted to carry a pair of fixed cutting blades in a spaced-apart relationship, the cutting member positioned to pivot about a transverse axis to reciprocate between the fixed cutting blades, the cuffing member comprising:
a body operatively coupled to the motor;
a blade projecting from the body, the blade having spaced-apart first and second side surfaces and a top surface between the first and second side surfaces; and
a waste ejection member at a distal portion of the top surface, the waste ejection member including a ramp having a front edge, a back edge, and an inclined surface between the front and back edges, the inclined surface being canted toward one of the fixed cutting blades.

35. A fiber-cement cutting tool, comprising:
a hand-held motor unit having a housing, a motor inside the housing, and a switch operatively coupled to the motor to selectively activate the motor;
a head having a casing attached to the housing of the motor unit and a reciprocating drive assembly coupled to the motor;
a first finger attachable to the head or motor unit, the first finger having a first guide surface and a first interior surface transverse to the first guide surface;
a second finger having a second guide surface and a second interior surface transverse to the second guide surface, the second finger being attachable to the head or motor unit to position the first and second guide surfaces in a guide plane and to space the first and second interior surfaces apart from one another; and
a reciprocating cutting member between the first and second fingers for severing fiber-cement along a cutting path, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a waste ejection member at a rear portion of the top surface, the waste ejection member including a ramp having a front edge, a back edge, and an inclined portion between the front and back edges, the inclined portion being canted toward the first or second finger.

36. A fiber-cement cutting tool, comprising:
a hand-held motor unit having a housing, a motor inside the housing, and a switch operatively coupled to the motor to selectively activate the motor;
a head having a casing attached to the housing of the motor unit and a reciprocating drive assembly coupled to the motor;
a first finger having a first guide surface and a first interior surface, the first finger being attachable to the head or motor unit to position the first guide surface in a first guide plane;
a second finger having a second guide surface and a second interior surface, the second finger being attachable to the head or motor unit to space the first and second interior surfaces apart from one another and to position the second guide surface in a second guide plane, wherein the first and second guide planes are offset from each other; and
a reciprocating cuffing member pivotally coupled between the first and second fingers, the cutting member having a body and a blade projecting from the body, the body being pivotally coupled to the first and second fingers, the blade having a first side surface facing the first interior surface of the first finger, a second side surface facing the second interior surface of the second finger, and a top surface between the first and second side surfaces, the top surface having an arcuate portion configured to be a cutting surface.

37. A method for cutting fiber-cement, comprising:
engaging a first surface of the fiber-cement with guide surfaces of two spaced-apart finger portions of a cutting tool;
reciprocating a blade between the fingers in a direction transverse to the guide surfaces along a stroke between an open position and a closed position;
moving the fiber-cement and/or the cutting tool relative to the other along a cutting path; and
ejecting waste portions cut from the workpiece away from the blade toward one of the finger portions.

38. The method of claim 37 wherein ejecting waste portions of the workpiece comprises redirecting the waste portions toward the first or second finger with a waste ejection member at a rear portion of the top surface of the blade.

39. The method of claim 37 wherein engaging a first surface of the fiber-cement with guide surfaces of two spaced-apart finger portions comprises engaging the fiber-cement with a first guide surface having a first guide plane and a second guide surface having a second guide plane, and wherein the first and second guide planes are offset from each other such that at least one of the first and second guide surfaces does not lie flush against the face of the workpiece while the workpiece is cut.
